(19) United States
(12) Patent Application Publication
(10) Pub. No.: US 2017/0121221 A1
(43) Pub. Date: May 4, 2017

(54) APPARATUS AND METHOD FOR FABRICATING METAL-COATED OPTICAL FIBER

(71) Applicant: AFL TELECOMMUNICATIONS LLC, Duncan, SC (US)

(72) Inventor: Matsuhiro Miyamoto, Sakura-shi (JP)

(21) Appl. No.: 15/316,996

(22) PCT Filed: Jun. 9, 2015
(86) PCT No.: PCT/US15/34883

§ 371 Date: Dec. 7, 2016

Related U.S. Application Data
(60) Provisional application No. 62/009,546, filed on Jun. 9, 2014.

(51) Int. Cl. C03C 25/10; G02B 6/02; B05C 3/172; C03C 25/16; C03C 25/68

(52) U.S. Cl. CPC C03C 25/108; C03C 25/16; C03C 25/68; B05C 3/172; G02B 6/02395

(57) ABSTRACT

Apparatus and method for producing metal-coated optical fiber is provided. One step of such a method comprises providing a length of optical fiber having a glass fiber with or without a carbon layer surrounded by a polymeric, thermoplastic resin or wax coating. The optical fiber is passed through a series of solution baths such that the fiber will contact the solution in each bath for a predetermined dwell time, the series of solution baths or thermal tooling effecting removal of the polymer, thermoplastic resin or wax coating and subsequent electroless plating of metal on the glass fiber. The optical fiber is collected after metal plating so that a selected quantity of said metal-coated optical fiber is gathered. At least one of the solution baths comprises a coiled tube containing the process solution through which the glass fiber passes. Aspects of the present invention are also applicable to conventional metal wire where it is desirable to reduce physical length of the process line.

### BACKGROUND OF THE INVENTION

The present invention relates to optical fiber. More particularly, the present invention relates to a metal-coated optical fiber, and techniques for manufacturing same. Optical fiber is typically constructed having a polymer coating, but some applications necessitate the use of metal-coated optical fiber. Current metal-coated optical fibers are typically manufactured by a liquid freezing method or metal plating method. The liquid freezing method is described in detail in A. Mendez & T. F. Morse, Specialty Optical Fibers Handbook, Academic Press (2007), at pages 491-510 (“Metal-Coated Fibers”), which is incorporated herein by reference in its entirety for all purposes. As a brief description of the liquid freezing method, optical fiber is coated with metal by the fiber passing though a die filled with liquid metal or molten metal in line with a fiber drawing process.

Particularly when the thickness of metal coating is decreased to less than ten micron, this freezing process has the possibility of mechanical contact of optical fiber with the coating die due to small fluctuation of the drawing tower or environmental conditions (such as temperature change, wind, vibration, etc.). A bare fiber without a thick polymer coating is fragile against handling or mechanical contact with any hard material. (A thin carbon layer is sometimes coated in line with drawing as a hermetic barrier. It will be appreciated that an optical fiber with a carbon layer less than one micron without any additional coating is still fragile against normal handling.) So any mechanical contact with hard material can cause mechanical damage on the optical fiber surface and can degrade long term mechanical reliability.

In order to avoid mechanical contact of fiber with the coating die, the typical coating thickness of metal-coated fiber made by a liquid freezing method is larger than ten micron to obtain enough mechanical strength. However, the transmission loss of fiber with a thicker metal coating is larger due to thick metal thermal contraction. In particular, the contraction of the metal layer causes microbending loss when metal shrinks from liquid phase to solid phase due to thermal expansion coefficient.

For metal-coated fiber exhibiting lower losses, thicker glass diameter needs to be selected (e.g., more than about 200 micron) to resist microbending due to metal contraction. But thick diameter of 200 micron or greater limits bending radius due to larger bending strain.

Referring now to FIG. 1, another method of coating optical fiber with metal is plating. Electroplating or electroless plating is a wet process which means the fiber is immersed in liquid solution baths. The metal is coated on the glass fiber as a result of chemical reaction in a liquid. Typically, optical fiber is dipped in several baths in series for cleaning, sensitizing, activation and plating. Each wet process takes one to several minutes to occur in each of the baths. (The process time depends on coating thickness and temperature.) As illustrated by the downward arrows in FIG. 1, short fibers or fiber ends are easily dipped in a bath. (See, for example, U.S. Pat. No. 5,380,559, incorporated herein by reference in its entirety for all purposes.) Each target fiber moves vertically and is immersed in a bath. After sufficient time, it is retracted from the bath and moved horizontally to the top of the next bath. The plating will be done by soaking in a series of such baths. While this process is suitable for short fiber (such as one meter or less) or fiber ends of plating, continuous fibers cannot be coated in a batch line.

Referring now to FIG. 2, conventional metal wire can be coated in a continuous process. As shown, the wire contacts one or more cathode rolls as it proceeds through the process. Additional pulleys may also be provided along the process direction to facilitate movement of the wire. One skilled in the art will appreciate that conventional wire (unlike optical fiber) is robust for handling or bending with tension because it is made of metal rather than glass. (See U.S. Pat. Nos. 5,342,503 and 3,994,786, each of which is incorporated by reference in its entirety for all purposes.)

Optical fiber cannot be coated using the same coating process that has been used with metal wire. If the bare fiber is prepared and enters into wet baths by contacting with pulleys, the pulleys can damage the fiber. In particular, such pulleys are typically made of plastic or metal on the surface, which is hard and can damage the fibers through contact. Even if the pulleys are made of soft material, small dust of hard particles such as silica or metal or any solids may cause damage to the optical fiber's surface due to fiber tension when some such particles exist between fiber and pulley. The bare fiber travels along path line in contact with some pulleys and therefore mechanical damage is caused at some points along the fiber length statistically. So bare fiber is not applicable to metallic continuous plating process to achieve long metal-coated optical fiber. As a result, most application of metal plating to optical fiber is metallization of short ends of optical fiber.

The present invention recognizes the foregoing considerations, and others, of the prior art.

### SUMMARY OF THE INVENTION

In accordance with one aspect, the present invention provides apparatus and method for producing metal-coated optical fiber. One step of such a method comprises providing a length of optical fiber having a glass fiber with or without a carbon layer surrounded by a polymeric, thermoplastic resin or wax coating. The optical fiber is passed through a series of solution baths such that the fiber will contact the solution in each bath for a predetermined dwell time, the series of solution baths or thermal tooling effecting removal of the polymer, thermoplastic resin or wax coating and subsequent electroless plating of metal on the glass fiber. The optical fiber is collected after metal plating so that a selected quantity of said metal-coated optical fiber is gathered. At least one of the solution baths comprises a coiled tube containing the process solution through which the glass fiber passes. Aspects of the present invention are also applicable to conventional metal wire where it is desirable to reduce physical length of the process line.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention to one of ordinary skill in the art, is set forth more particularly in the remainder of the specification, including reference to the accompanying drawings, in which:

FIG. 1 is a diagrammatic representation showing a batch plating process of the prior art used to create short lengths of metal-coated optical fiber.

FIG. 2 is a diagrammatic representation showing a continuous coating process of the prior art to coat conventional metal wire.

FIG. 3 is a perspective diagrammatic view of a metal-coated optical fiber with layers cut away.

FIG. 4 illustrates an exemplary process for coating optical fiber with metal in accordance with an embodiment of the present invention.

FIG. 5 is a diagrammatic representation of a coiled tube bath arrangement that may be used in the process of FIG. 4 in accordance with an embodiment of the present invention.

FIG. 6 is a diagrammatic representation of a manifold that may be used with the bath arrangement of FIG. 5.

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

The present invention provides various improvements in metal-coated optical fiber and methods of making the same, as well as improvements in the processing of conventional metal wire. In particular, metal plating may be applied along continuous lengths of optical fiber (such as lengths up to ten kilometers) with sufficient mechanical strength along the whole length. According to an important aspect of the present invention, metal-coated optical fibers may be coated by a continuous plating process in which a bare fiber enters into several liquid baths one or more of which are adapted to reduce physical equipment length.

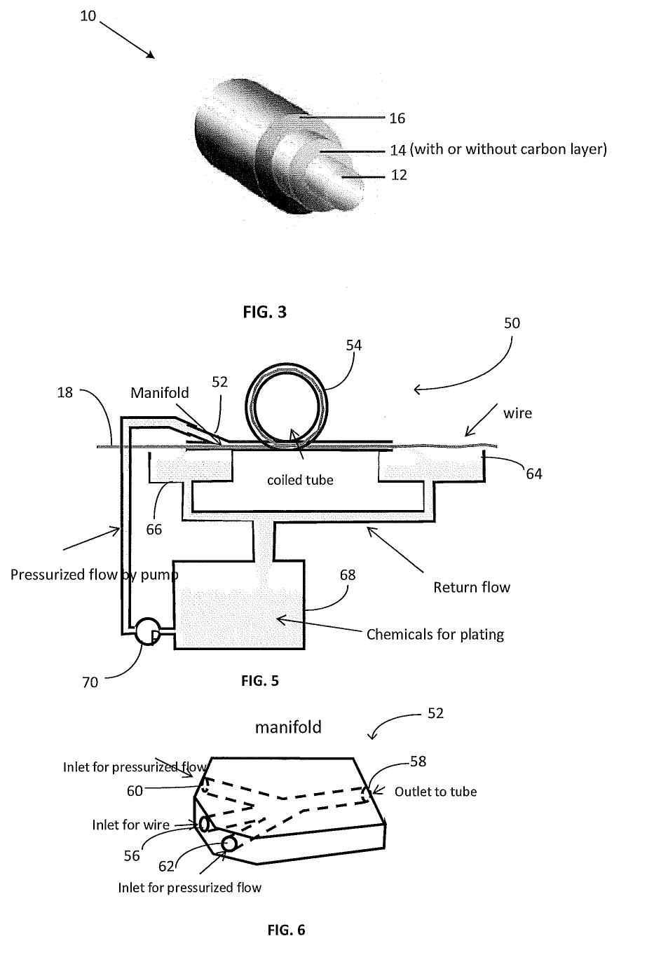

Referring now to FIG. 3, an exemplary metal-coated fiber 10 is illustrated. Fiber 10 includes a glass fiber having a core 12 and a cladding 14. A metal coating 16 surrounds and contains the cladding/core combination. Metal coating 16 may be formed of any suitable metal which may be applied by electroless plating, such as nickel, copper, gold, silver, or suitable alloys. In accordance with a preferred embodiment, the diameter of the cladding/core combination may often be less than about 200 micron with the metal coating 16 often having a thickness less than about ten micron.

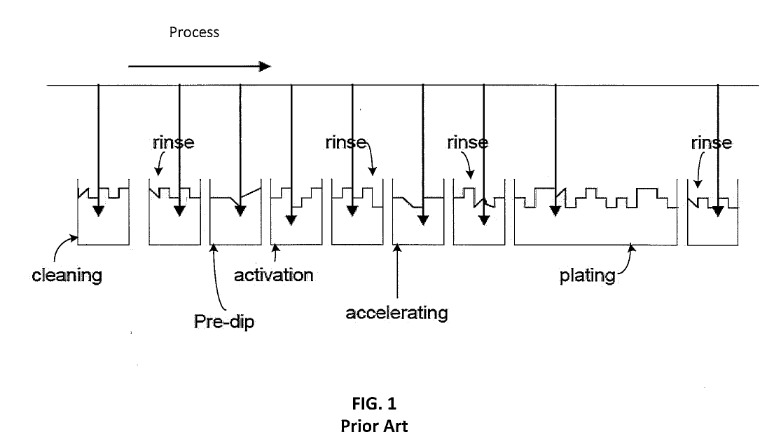

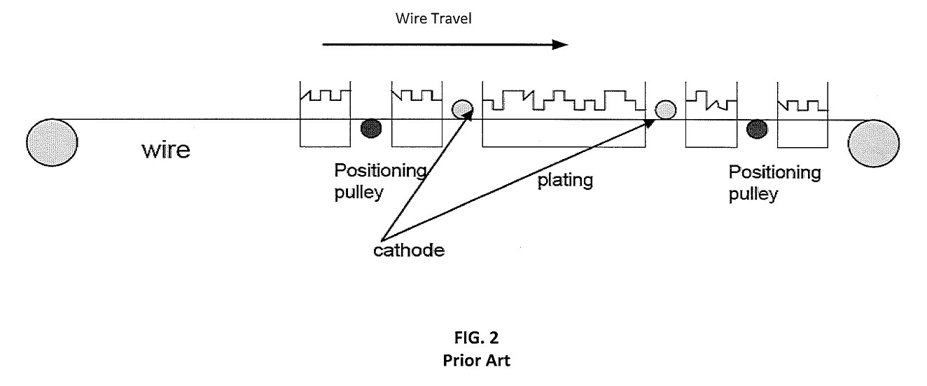

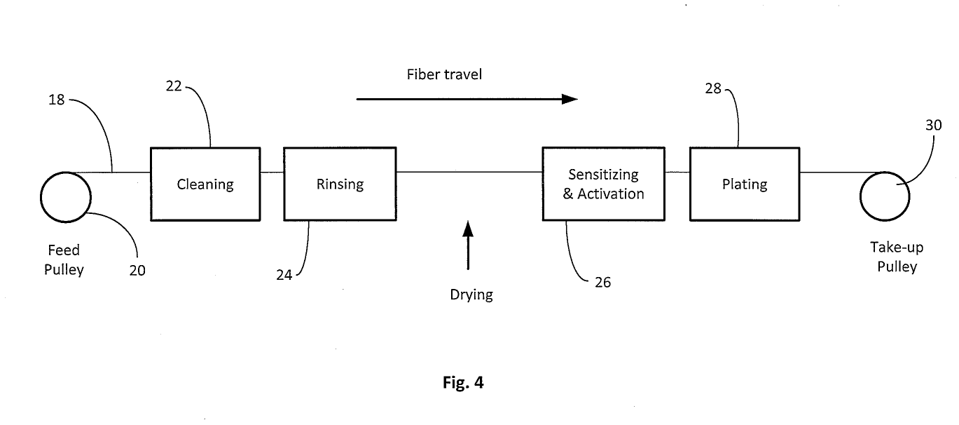

FIG. 4 is a diagrammatic representation of an exemplary process in accordance with the present invention for producing metal-coated optical fiber on a continuous basis. According to this embodiment, the fiber 18 is processed in successive liquid baths corresponding to the baths in FIG. 1, such as cleaning (degrease), rinsing, sensitizing, activating and plating, without any physical contact with pulleys (until the fiber becomes enough robust with metallic deposition growth to be handled). The fiber enters the process via the feed pulley 20 and proceeds to a cleaning bath 22. (In some embodiments, a separate coating removing bath may be provided before bath 22 to remove the protective coating, which may preferably be a water soluble coating.) After leaving the cleaning bath, the fiber enters a rinsing bath 24. After rinsing bath 24, the fiber is allowed to dry before entering a sensitizing bath 26. After plating in bath 28, the process ends at take-up pulley 30.

At feed pulley 20, the fiber will preferably have a typical polymer coating which prevents contact between the optical fiber glass and the pulley. The polymer is stripped in cleaning bath 22 using a suitable solvent in the cleaning solution, such as acetone, MEK, etc. Sometimes another bath soaking such as acids, alkalis, surface treatment chemicals may be added for etching or cleaning of particular residuals. At take-up pulley 30, the fiber has been sufficiently strengthened by the metal coating in order to contacted again. One skilled in the art will appreciate that the fiber's duration of transit through the process and the geometry of the respective baths are set so that the fiber will have sufficient dwell time in each bath.

Copending PCT application serial no. PCT/US2014/028151, entitled “METHOD AND APPARATUS FOR FABRICATION OF METAL-COATED OPTICAL FIBER, AND THE RESULTING OPTICAL FIBER” and published Sep. 25, 2014 as WO 14/152896, describes one configuration of an arrangement for each of the baths in the process of FIG. 4. In the arrangement described in that PCT application (which is incorporated by reference herein for all purposes), fiber 18 passes through exits of a bath vessel where liquid flows out such that the fiber is below the level of liquid. As a result, the optical fiber does not contact anything except the process solution. One skilled in the art will appreciate that soaking time in such a bath is determined by soaking length when a wire-like optical fiber is plated continuously. The fiber to be plated goes through soaking bath horizontally without contact to any hard material because the surface of the material to be plated should not be damaged by the contact before protective plated coating. So the plating thickness is determined mainly by soaking time, that is, soaking bath length if bath solutions are optimized.

Thus, length of the bath where fiber goes through straight without contact to any hard material needs to be increased when higher line speed is considered for productivity. But usually straight line length for production is limited by existing room length or other reasons. So line speed is limited by physical length of plating line. For example, deposit speed of one micron thickness for electroless copper plating will take 15-20 minutes. This means that 15-20 m of soaking length is necessary for the case of line speed of 1 m/min. As noted above, fiber typically goes through several baths successively for pre-treatment, rinsing and additional plating. In total, more than 50 m of line length seems necessary for straight line plating.

FIG. 5 illustrates one configuration of a bath arrangement 50 that can be used in the process of FIG. 4 to allow sufficient process length for plating while minimizing physical length of process equipment. In this case, fiber 18 passes through a manifold 52 into a coiled tube 54. The coiled tube 54 is filled with process solution and has a total interior length dictated by the necessary line length of the particular process step. Fiber 18 (“wire”) passes out of coiled tube 54 into the next bath or take-up pulley, as the case may be. Coiled tube 54 should be made of a material which facilitates flow of process fluid and which will not damage the fiber as it moves. For example, the coiled tube 54 may be formed of HDPE or vinyl. Particularly in the case of optical fiber, the radius of the coiled tube should be greater than the bend radius of the fiber to prevent the fiber from breaking. The smaller the radius of coiled tube, the shorter the feeding length in general. The liquid flow rate of coiled tube is reduced by making coiled tube radius small if pump pressure is fixed and then, driving force to the fiber becomes small.

Referring now also to FIG. 6, it can be seen that manifold 52 has three inlets in this embodiment that converge inside of the manifold housing. Fiber 18 passes into the central inlet 56 through a straight central passage to the outlet 58. Outlet 58 is, in turn, located at the inlet of coiled tube 54. Inlets 60 and 62 are oblique to the central passage, as shown. Process fluid is forced into inlets 60 and 62 under pressure. As a result, chemical solutions for plating comes out from the outlet of manifold 52 and fills the coiled tube 54. In the case of a plating solution, fiber 18 will thus be plated to the desired thickness after it exits the coiled tube.

Various type of manifold could be applicable. An important consideration for design of the manifold is to decrease the back flow of liquid from the inlet of fiber as much as possible. Also, the liquid flow at the manifold should not bend the optical fiber by turbulence at yielding region. The guide tube which protects bending and reduces back flow is effective. The number of liquid input is preferably at least two for circumferentially even flow.

Referring again to FIG. 5, certain additional details about the bath arrangement 50 can be described. As can seen, process fluid exiting the coiled tube 54 is collected in a suitable basin 64. Some process fluid also exits the manifold inlet 56 due to back flow. (This back flow can be minimized by narrowing the inlet diameter.) Thus, a basin 66 is also provided to collect the fluid back flow through the inlet. Fluid collected in basins 64 and 66 is returned (e.g., by gravity) to a fluid reservoir 68. The fluid in the reservoir is re-circulated back to the manifold inlet, such as by a pump 70. Preferably, the pump provides sufficient pressure to keep coiled tube 54 full with flowing fluid.

In addition, the fluid flowing due to pump 70 will preferably have sufficient pressure to pull fiber 18 through and out of the coiled tube. For example, fiber 18 may be paid off of feed pulley 20 at a constant speed which is equal to or less than the desired feeding speed of fiber through coiled tube 54. The feeding speed is a function of pressure of liquid, tube diameter, tube length and tube material. In accordance with preferred methodology, the following parameters are believed to produce acceptable results: Pump pressure 7.2 PSI, coiled tube: ⅜ inch inner diameter, 48 foot length, made of HDPE, coil diameter 14 inches (the coil diameter was chosen from the viewpoint of allowable space). Such parameters produced 0.92 flow rate at outlet and 0.2 m/min feed speed. If longer length or faster feed speed is desired, this can be achieved using higher pump pressure. Embodiments utilizing a horizontal coiled loop are also contemplated.

One skilled in the art will appreciate that various advantages are achieved by a system configured in accordance with the present invention. Notably:

(1) Coiled tube contributes space savings because plating will occur along a tube.

(2) Tube filled with chemicals for plating is good for loading factor because of its compactness.

(3) Flow of chemicals along tube will drive a wire along tube. This driving force will determine the soaking time as passing time. The line speed is controlled by flow rate or pressure in tube.

While preferred embodiments of the invention have been shown and described, modifications and variations may be made thereto by those of ordinary skill in the art without departing from the spirit and scope of the present invention. For example, while the “wire” is described above as an optical fiber, one skilled in the art will appreciate that aspects of the present invention are also applicable to electroless plating of conventional metal wire. In addition, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. A method for producing metal-coated optical fiber, said method comprising:
(a) providing a length of optical fiber having a glass fiber with or without a carbon layer surrounded by a removable protective coating;
(b) passing said optical fiber through a series of solution baths such that the fiber will contact the solution in each bath for a predetermined dwell time, the series of solution baths or thermal tooling effecting removal of said protective coating and subsequent electroless plating of metal on the glass fiber; and
(c) collecting the optical fiber after metal plating so that a selected quantity of said metal-coated optical fiber is gathered,
wherein at least one of the solution baths comprises a coiled tube containing the process solution through which the glass fiber passes.

2. The method as set forth in claim 1, wherein the process solution is continuously pumped into the coiled tube.

3. The method as set forth in claim 2, wherein a manifold is situated at the entrance to the coiled tube, the manifold defining a straight passage through which the fiber passes and at least one fluid inlet that converges with the straight passage.

4. The method as set forth in claim 3, wherein the manifold comprises at least two fluid inlets that converge with the straight passage.

5. The method as set forth in claim 2, wherein the process solution is pumped with sufficient pressure to pull along the glass fiber through the coiled tube at a desired line speed.

6. The method as set forth in claim 1, wherein said optical fiber has a bend radius, and said coiled tube has a coil diameter such that a coil radius is greater than said bend radius.

7. The method as set forth in claim 6, wherein said coil diameter is approximately 14 inches.

8. The method as set forth in claim 7, wherein the coiled tube has an internal diameter of no greater than about ⅜ inch.

9. The method as set forth in claim 6, wherein said coiled tube has a process length of at least 15 meters.

10. The method as set forth in claim 1, wherein said coiled tube comprises a plastic material that inhibits damage to said fiber as it moves.

11. The method as set forth in claim 9, wherein said plastic material comprises high density polyethylene (HDPE) or vinyl.

12. The method as set forth in claim 1, wherein said protective coating on said optical fiber is selected from the group consisting of a polymeric coating, a thermosplastic coating, and a wax coating.

13. An apparatus for use in processing of a string-like member being continuously fed thereto, said apparatus comprising:
a coiled tube having a predetermined coil diameter, internal diameter, and process length;
a manifold situated at the entrance to the coiled tube, the manifold defining a passage through which the string-like member passes and at least one fluid inlet by which process fluid is introduced into said coiled tube;
at least one collection basin positioned to collect process fluid as it exits said coiled tube; and
a pump operative to continuously pump said process fluid into said coiled tube.

14. An apparatus as set forth in claim 13, wherein said pump operates with sufficient pressure to pull along the string-like member through the coiled tube at a desired line speed.

15. An apparatus as set forth in claim 13, wherein said coiled tube has respective first and second straight sections before and after a coiled portion.

16. An apparatus as set forth in claim 15, wherein said coiled tube is formed of a plastic material that inhibits damage to said string-like member as it moves.

17. An apparatus as set forth in claim 16, wherein said plastic material comprises high density polyethylene (HDPE) or vinyl.

18. An apparatus as set forth in claim 13, wherein said passage of said manifold is substantially straight and said at least one fluid inlet converges with said straight passage at an oblique angle.

19. An apparatus as set forth in claim 18, wherein said at least one fluid inlet comprises at least two fluid inlets.

20. An apparatus as set forth in claim 13, wherein the collection basin drains into a reservoir by which the process fluid is recirculated.

21. An apparatus as set forth in claim 13, wherein said coiled tube has a process length of at least 15 meters.

22. An apparatus as set forth in claim 13, further comprising a feed mechanism for feeding off said string-like member toward said coiled tube.
